(19) United States
(12) Patent Application Publication
(10) Pub. No.: US 2026/0228786 A1
(43) Pub. Date: Aug. 6, 2026

(54) MULTIMODAL EMBEDDING SYSTEM FOR BUSINESS RECOMMENDATIONS

(71) Applicant: BILL OPERATIONS LLC, San Jose, CA (US)

(72) Inventors: Changlin Zhang, Saratoga, CA (US); Kartik Vasudev Shenoy, San Jose, CA (US); Gaurav Tandon, Sammamish, WA (US); Mohsen Sardari, Burlingame, CA (US); Max Stepin, Redmond, WA (US); Ken Moss, Menlo Park, CA (US); Amol Thatte, Simi Valley, CA (US); Deepanshu Lulla, New Providence, NJ (US)

(21) Appl. No.: 19/043,191

(22) Filed: Jan. 31, 2025

(51) Int. Cl. G06Q 30/04; G06F 16/2457

(52) U.S. Cl. CPC G06Q 30/04; G06F 16/24578

(57) ABSTRACT

The present disclosure provides a system for generating and matching multimodal embeddings for business recommendations. The system includes a processor and a memory storing instructions that, when executed by the processor, cause the system to generate multimodal embeddings for vendor-payor network entities. The multimodal embeddings comprise document embeddings, payor-vendor network interaction embeddings, payor segment embeddings, and vendor segment embeddings. The system stores the multimodal embeddings in a vector database, retrieves embeddings from the vector database in response to a query for an entity, matches and reranks retrieved results against the query, and implements sanity checks to minimize false positives in recommendations.

### FIELD OF THE INVENTION

The present invention relates to systems and methods for generating and matching multimodal embeddings, and more particularly to a multimodal embedding system for business recommendations in vendor-payor networks.

### BACKGROUND

Currently, in today's rapidly evolving business landscape, efficient management of vendor-payor relationships has become increasingly crucial for organizations of all sizes. The complexity of these relationships, coupled with the vast amount of data generated through various interactions, presents significant challenges in terms of data organization, retrieval, and utilization for informed decision-making.

Traditional methods of managing vendor-payor networks often rely on manual processes, which are time-consuming, prone to errors, and lack scalability. As businesses grow and their networks expand, the volume of documents, transactions, and interactions increases exponentially, making it difficult to maintain accurate records and derive meaningful insights from the available data.

The advent of digital technologies has led to the creation of various software solutions aimed at streamlining vendor-payor relationship management. However, many of these solutions still struggle to effectively capture and represent the multifaceted nature of these relationships. They often fail to account for the diverse types of data involved, including structured information from databases, unstructured text from documents, and behavioral data from user interactions.

As such, there is thus a need for addressing these and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a system for generating and matching multimodal embeddings for business recommendations, including: a processor; and a memory storing instructions that, when executed by the processor, cause the system to: generate multimodal embeddings for vendor-payor network entities, wherein the multimodal embeddings include document embeddings, payor-vendor network interaction embeddings, payor segment embeddings, and vendor segment embeddings; store the multimodal embeddings in a vector database; retrieve embeddings from the vector database in response to a query for an entity; match and rerank retrieved results against the query; and implement sanity checks to minimize false positives in recommendations.

In some aspects, the techniques described herein relate to a system, wherein generating the document embeddings includes: extracting textual information from documents; analyzing positional information of text fields within the documents; and capturing visual information, wherein the visual information includes at least two of logos, font sizes, or table designs.

In some aspects, the techniques described herein relate to a system, wherein generating the document embeddings further includes using a transformer architecture to process the textual information and the positional information.

In some aspects, the techniques described herein relate to a system, wherein the transformer architecture includes at least one of: LayoutLM, models designed for document layout analysis, bi-directional transformers, decoder-only transformers, encoder-only transformers, or encoder-decoder transformers.

In some aspects, the techniques described herein relate to a system, wherein capturing the visual information includes: locating the logos within the documents; and determining logo representations using convolutional neural networks.

In some aspects, the techniques described herein relate to a system, wherein generating the payor-vendor network interaction embeddings includes analyzing: payment frequency between payers and vendors; payment amounts and dates; bill descriptions; line items; and expense and approver chains.

In some aspects, the techniques described herein relate to a system, wherein generating the payor segment embeddings includes analyzing: payer business information; account software usage; login information; transaction behaviors; and payment trends.

In some aspects, the techniques described herein relate to a system, wherein generating the vendor segment embeddings includes analyzing: vendor information created by payers; invoice documents sent to payers; and payment methods accepted by vendors.

In some aspects, the techniques described herein relate to a system, wherein storing the multimodal embeddings in the vector database includes: compressing the embeddings to reduce storage requirements; storing metadata alongside the embeddings; and sharding the embeddings across multiple nodes for parallel processing.

In some aspects, the techniques described herein relate to a system, further including caching frequently accessed embeddings to reduce retrieval time.

In some aspects, the techniques described herein relate to a system, wherein retrieving embeddings from the vector database includes: converting the query into a multimodal embedding tensor; and performing a k-nearest neighbor search across distributed shards.

In some aspects, the techniques described herein relate to a system, further including applying a merge sort algorithm to aggregate query results from distributed instances.

In some aspects, the techniques described herein relate to a system, wherein matching and reranking retrieved results includes: calculating similarity scores between the query embedding and retrieved embeddings; and ordering the results based on the similarity scores.

In some aspects, the techniques described herein relate to a system, wherein calculating similarity scores includes using cosine similarity.

In some aspects, the techniques described herein relate to a system, wherein implementing sanity checks includes: applying a machine learning model trained on known information about documents, payment patterns, and payer-vendor preferences; and optimizing the model using an F1 score to balance precision and recall.

In some aspects, the techniques described herein relate to a system, further including personalizing recommendations for different users or entities by: ingesting real-time updates of user and entity preferences; and inferencing upon historical payer-vendor behaviors and trends.

In some aspects, the techniques described herein relate to a system, further including detecting duplicate documents by: generating document text embeddings from optical character recognition; creating document entity recognition embeddings; and comparing similarities between input embeddings and existing embeddings.

In some aspects, the techniques described herein relate to a system, further including handling multilingual documents by incorporating a language-agnostic embedding model.

In some aspects, the techniques described herein relate to a system, further including improving the quality of generated embeddings over time using a triplet loss siamese network.

In some aspects, the techniques described herein relate to a system, wherein the triplet loss siamese network minimizes the distance between embeddings for similar inputs while maximizing the distance between embeddings for dissimilar inputs.

In some aspects, the techniques described herein relate to a system, wherein the vector database utilizes a dynamic indexing mechanism to enhance retrieval efficiency.

In some aspects, the techniques described herein relate to a system, wherein the embeddings are further processed to remove noise before storage.

In some aspects, the techniques described herein relate to a system, wherein the system further includes a user interface module to receive queries in natural language.

In some aspects, the techniques described herein relate to a system, wherein the system further includes a feedback module to collect user feedback on the accuracy of the recommendations.

In some aspects, the techniques described herein relate to a system, wherein the system further includes a reporting module to generate analytics reports based on the retrieved and matched results.

In some aspects, the techniques described herein relate to a system, wherein the system further includes a notification module to alert users about significant changes in the vendor-payor network.

In some aspects, the techniques described herein relate to a system, wherein the system further includes a data enrichment module to augment the embeddings with external data sources.

In some aspects, the techniques described herein relate to a system, wherein the system further includes a security module to monitor and mitigate potential security threats in real-time.

In some aspects, the techniques described herein relate to a system, wherein the system further includes a data synchronization module to ensure consistency across distributed storage nodes.

In some aspects, the techniques described herein relate to a system, wherein the system further includes a load balancing module to distribute processing load evenly across the system.

In some aspects, the techniques described herein relate to a system, wherein the system further includes a disaster recovery module to handle system failures and data recovery processes.

In some aspects, the techniques described herein relate to a system, wherein the system further includes a scalability module to dynamically adjust resources based on system demand.

In some aspects, the techniques described herein relate to a system, wherein the system further includes a customization module to allow users to customize the parameters of the embedding generation.

In some aspects, the techniques described herein relate to a system, wherein the system further includes a version control module to manage different versions of the embeddings.

In some aspects, the techniques described herein relate to a system, wherein the system further includes a data privacy module to ensure compliance with global data protection regulations.

In some aspects, the techniques described herein relate to a system, wherein the system further includes a performance optimization module to enhance the speed and efficiency of the system.

In some aspects, the techniques described herein relate to a system, wherein the system further includes a data visualization module to visually represent the embeddings and query results.

In some aspects, the techniques described herein relate to a system, wherein the system further includes a predictive analytics module to forecast trends based on historical data.

In some aspects, the techniques described herein relate to a system, wherein the system further includes a machine learning training module to continuously improve the accuracy of the embeddings.

In some aspects, the techniques described herein relate to a system, wherein the system further includes a data archiving module to store historical embeddings for long-term analysis.

In some aspects, the techniques described herein relate to a system, wherein the system further includes a multi-tenancy module to support multiple users or organizations simultaneously.

In some aspects, the techniques described herein relate to a system, wherein the system further includes a data integrity module to verify the accuracy and completeness of the data.

In some aspects, the techniques described herein relate to a system, wherein the system further includes a data migration module to facilitate the transfer of data between different storage systems.

In some aspects, the techniques described herein relate to a system, wherein the system further includes a data compression module to reduce the size of the embeddings for storage efficiency.

In some aspects, the techniques described herein relate to a system, wherein the system further includes an error handling module to manage and resolve processing errors.

In some aspects, the techniques described herein relate to a system, wherein the system further includes a data deduplication module to eliminate redundant data in the embeddings.

In some aspects, the techniques described herein relate to a system, wherein the system further includes a collaborative filtering module to enhance recommendation accuracy based on user collaboration.

In some aspects, the techniques described herein relate to a system, wherein the system further includes an anomaly detection module to identify and address outliers in the data.

In some aspects, the techniques described herein relate to a system, wherein the system further includes a continuous learning module to adapt to new data without manual reconfiguration.

In some aspects, the techniques described herein relate to a system, wherein the system further includes an audit trail module to track changes and access to the system for security and compliance.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates a flowchart of a method for generating and matching multimodal embeddings for business recommendations, according to aspects of the present disclosure.

FIG. 2 illustrates a block diagram of an embedding system for generating multimodal embeddings, in accordance with example embodiments.

FIG. 3 illustrates a system architecture for generating and processing multimodal embeddings, according to an embodiment.

FIG. 4 illustrates a block diagram of an embedding system for generating and storing multimodal embeddings, according to aspects of the present disclosure.

FIG. 5 illustrates a block diagram of an embedding system for generating multimodal embeddings, in accordance with example embodiments.

FIG. 6 illustrates a system architecture for generating and matching multimodal embeddings, according to an embodiment.

FIG. 7 illustrates a flowchart of a recommendation filtering process, according to aspects of the present disclosure.

FIG. 8 illustrates a similarity graph showing relative similarity scores for different types of embeddings, in accordance with example embodiments.

FIG. 9 illustrates a system architecture for processing and managing vector data, in accordance with example embodiments.

FIG. 10 illustrates a network architecture, in accordance with one possible embodiment.

FIG. 11 illustrates an exemplary system, in accordance with one embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure addresses the challenge of efficiently managing and leveraging complex vendor-payor relationships in modern business environments. As organizations grow and their networks expand, the volume of documents, transactions, and interactions increases exponentially, making it difficult to maintain accurate records and derive meaningful insights from the available data. Traditional methods of managing vendor-payor networks often rely on manual processes or software solutions that struggle to effectively capture and represent the multifaceted nature of these relationships.

In contrast, the system described herein improves upon existing solutions by utilizing multimodal embeddings to process and analyze diverse data types, including structured information from databases, unstructured text from documents, and behavioral data from user interactions. By generating comprehensive multimodal embeddings that incorporate document, network interaction (including transactional information), payer segment, and vendor segment information, the system enables more accurate and relevant business recommendations. This approach enhances decision-making processes, optimizes business relationships, and provides personalized insights based on historical data, industry trends, and individual preferences.

In particular, the method and system disclosed herein provide a novel comprehensive multimodal embedding approach that captures and integrates diverse aspects of vendor-payor relationships. Unlike traditional systems that may rely on single-modal data or manual processes, the present multimodal system uses multimodal embeddings that are processed through a sophisticated architecture (for example that includes parallel processing paths, distributed storage, and/or advanced matching algorithms).

Additionally, the system disclosed herein may incorporate visual (and/or also textual, layout, etc.) information from documents, analyze temporal patterns in interactions, and implement sanity checks to minimize false positives in recommendations. By leveraging techniques such as transformer architectures, convolutional neural networks, and triplet loss siamese networks, the system may continuously improve the quality of generated embeddings over time. This holistic approach may enable more accurate, relevant, and personalized business recommendations while efficiently handling large volumes of data and complex queries across multilingual documents.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

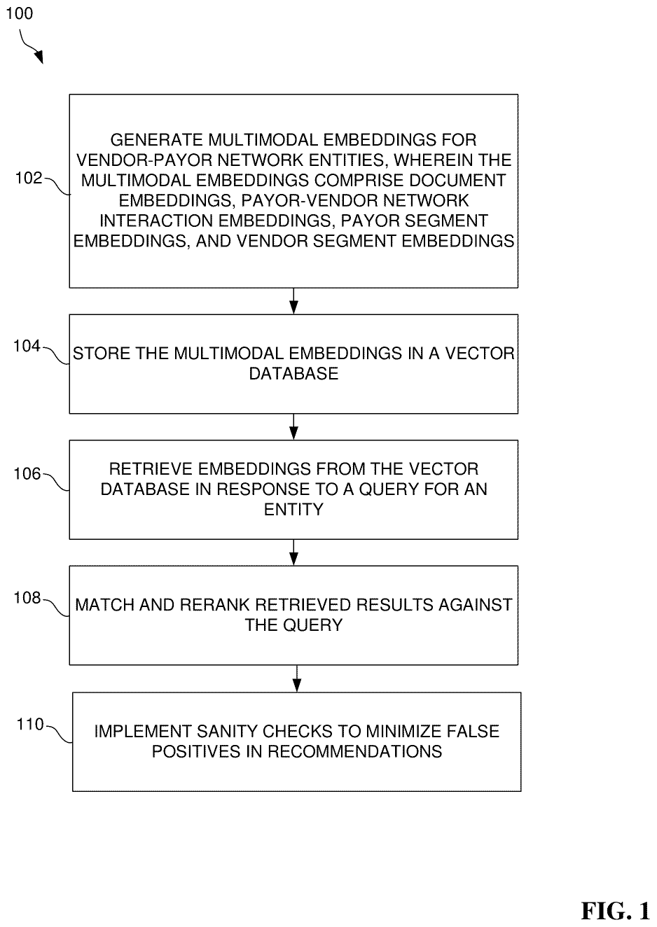

FIG. 1 illustrates a flowchart of a method 100 for generating and matching multimodal embeddings for business recommendations, in accordance with one embodiment. As an option, the method 100 may be implemented in the context of any one or more of the embodiments set forth in any previous and/or subsequent Figures and/or description thereof. Of course, however, the method 100 may be implemented in the context of any desired environment. Further, the aforementioned definitions may equally apply to the description below.

The method 100 may be performed by an embedding system comprising a processor and a memory. The method 100 includes a step 102 of generating multimodal embeddings for vendor-payor network entities. In some cases, the multimodal embeddings may comprise document embeddings, payor-vendor network interaction embeddings, payor segment embeddings, and vendor segment embeddings. The generation of these diverse embeddings allows the system to capture various aspects of the vendor-payor relationships and associated documents. In various embodiments, the multimodal embeddings may include multiple data modalities (e.g., text, images, audio, video). Additionally, in one embodiment, the multimodal embeddings may be stored in shared vector space. Further, the multimodal embeddings may be used in a variety of tasks, including but not limited to cross-modal retrieval, image captioning, audio-visual synchronization, etc.

By way of example, a multimodal embedding may be used to process an invoice document for a vendor-payor interaction. The system may generate a document embedding capturing textual content, layout information, and visual elements (such as logos from an invoice). The system may also create a payor-vendor network interaction embedding reflecting the payment history, frequency, and patterns between the specific payor and vendor. Additionally, the system may produce a payer segment embedding incorporating the payor's business information, account software usage, and transaction behaviors, as well as a vendor segment embedding including the vendor's information as created by payers, invoice history, and accepted payment methods. These embeddings may be combined into a unified multimodal representation. When a user queries the system for vendor recommendations, this multimodal embedding can be used to identify similar vendors or flag potential issues in the relationship. For example, the system may detect discrepancies between the invoice amount and typical payment patterns, or identify vendors with similar profiles based on document structure and interaction history. As such, this multimodal approach may provide a more comprehensive and nuanced understanding of the vendor-payor relationship than could be achieved by analyzing any single aspect in isolation.

Following the generation of multimodal embeddings, the method 100 proceeds to a step 104 of storing the multimodal embeddings in a vector database. The vector database may provide efficient storage and retrieval capabilities for the high-dimensional embedding vectors. Additionally, the vector database may be designed to handle high-dimensional data (such as embeddings), providing optimized storage structures and indexing mechanisms that allow for fast and efficient retrieval of similar vectors. As such, the vector-based storage may allow for large-scale embedding-based systems.

Additionally, vector-based databases may be configured to allow for specialized algorithms for nearest neighbor search, such as approximate nearest neighbors (ANN) algorithms, enabling quick identification of similar embeddings for tasks like recommendation and anomaly detection in the vendor-payor network. As the number of vendor-payor interactions grows, the system may need to store and process large numbers (e.g. millions or even billions) of embeddings. Therefore, the vector-based databases may be built to scale horizontally to handle increasing amounts of data.

Further, the vector-based databases may allow for dimensionality reduction techniques, which may help in compressing the embeddings while preserving their semantic meaning, thus reducing storage requirements and improving query performance. The vector-based databases may also allow for real-time updates to the stored embeddings, which may be important for maintaining up-to-date representations of the dynamic vendor-payor relationships.

The method 100 then includes a step 106 of retrieving embeddings from the vector database in response to a query for an entity. This step allows the system to access relevant embeddings based on user queries or system-generated requests.

In various embodiments, retrieving embeddings from the vector database in response to a query for an entity may involve several sub-steps and/or techniques. For example, when a user submits a query, the system may convert this query into a multimodal embedding tensor, representing the query in the same high-dimensional space as the stored embeddings. The system may then perform a k-nearest neighbor search across distributed shards of the vector database to find the most similar embeddings to the query embedding. This search may utilize specialized indexing structures like hierarchical navigable small world (HNSW) graphs or inverted file systems to efficiently navigate the high-dimensional space.

Additionally, the retrieval process may also incorporate filtering based on metadata stored alongside the embeddings, allowing for more targeted searches. Additionally, the system may use caching mechanisms to store frequently accessed embeddings, reducing retrieval time for common queries. The retrieved embeddings, along with their associated metadata, may then be passed to subsequent stages of the system for further processing, such as matching, reranking, and generating recommendations.

After retrieval, the method 100 moves to a step 108 of matching and reranking retrieved results against the query. This step may involve comparing the query embedding with the retrieved embeddings and ordering the results based on similarity or relevance scores.

In various embodiments, the process of matching and reranking retrieved results against the query may involve sophisticated comparison techniques and scoring mechanisms. For example, the system may calculate similarity scores between the query embedding and each of the retrieved embeddings using metrics such as cosine similarity, Euclidean distance, dot product, etc. These similarity calculations may be performed efficiently using optimized linear algebra libraries or specialized hardware like GPUs. In one embodiment, the system may apply different weights to various components of the multimodal embeddings, emphasizing certain aspects based on the query context or user preferences. For instance, document embeddings might be given more weight for document-centric queries, while network interaction embeddings could be prioritized for relationship-focused queries.

In other embodiments, the system may also incorporate additional factors into the ranking process, such as the recency of the data, the reliability of the source, the historical performance of similar recommendations, etc. Machine learning models, such as learning-to-rank algorithms, may be employed to optimize the ranking based on user feedback and interaction data. The system may implement a cascading reranking approach, where an initial fast ranking is followed by more computationally intensive reranking on a subset of top results. This process may also involve ensemble methods, combining multiple ranking models to improve overall performance. The final ordered list of results may then be prepared for presentation to the user, potentially with additional post-processing steps such as diversity injection or personalization based on user profiles.

Finally, the method 100 includes a step 110 of implementing sanity checks to minimize false positives in recommendations. These sanity checks may involve additional verification processes or filters to ensure the accuracy and relevance of the recommendations generated by the system.

In various embodiments, implementing sanity checks to minimize false positives in recommendations may involve a multi-faceted approach combining rule-based filters, statistical analysis, and machine learning techniques. The system may apply a machine learning model trained on known information about documents, payment patterns, and payer-vendor preferences to evaluate the likelihood of a recommendation being relevant and accurate. This machine learning model may be optimized using an F1 score to balance precision and recall, ensuring that the filtering process effectively reduces false positives while maintaining a high level of relevant recommendations.

In various embodiments, the system may implement threshold-based checks on various metrics, such as similarity scores, historical interaction frequencies, and/or financial transaction amounts, to flag potentially anomalous recommendations. It may also employ time-based analysis to detect sudden changes in patterns that could indicate false positives. In one embodiment, the sanity checks may include cross-referencing recommendations against external data sources or business rules to ensure consistency with established policies and regulations. Additionally, the system may utilize anomaly detection algorithms to identify outliers in the recommendation set that may represent false positives. To handle evolving patterns and preferences, the sanity check mechanisms may incorporate feedback loops, allowing the system to learn from user interactions and continuously refine its filtering criteria. The system may also implement confidence scoring for recommendations, presenting only those that meet a certain confidence threshold to users. In cases of uncertainty, the system may flag recommendations for human review or request additional context from users to improve accuracy. These sanity checks may be applied at various stages of the recommendation process, from initial retrieval to final presentation, ensuring a multi-layered approach to minimizing false positives. As such, the sanity checks may be implemented (as shown) after step 108 (where the retrieved results are matched and reranked against the query), or may be potentially applied at any stage of the method 100.

It is to be understood that the method 100 provides a structured approach for leveraging multimodal embeddings in business recommendation systems. By generating, storing, retrieving, and processing these embeddings, the method 100 enables more accurate and relevant recommendations for vendor-payor network entities.

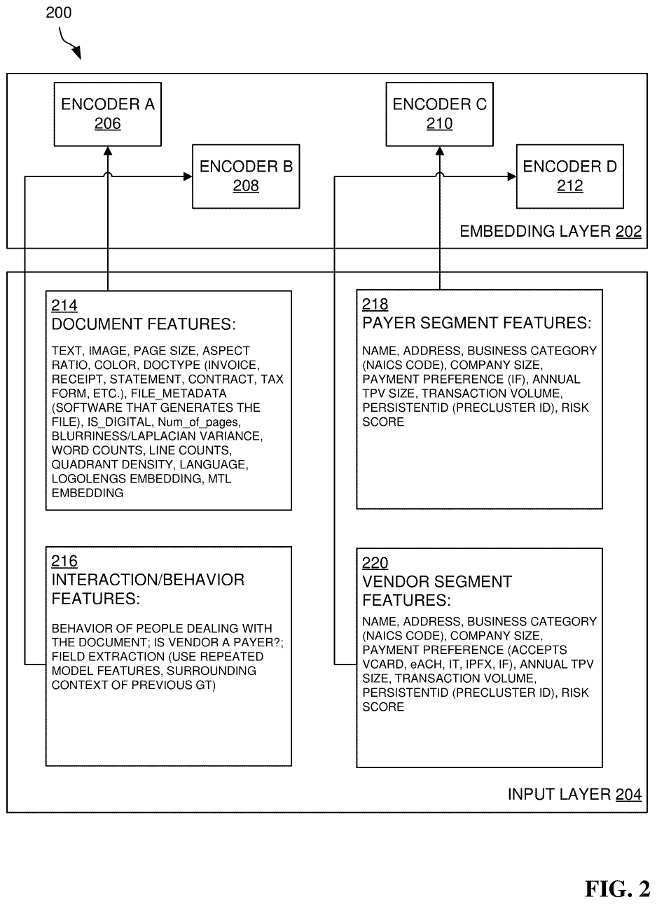

FIG. 2 illustrates a block diagram of an embedding system 200 for generating multimodal embeddings, in accordance with one embodiment. As an option, the embedding system 200 may be implemented in the context of any one or more of the embodiments set forth in any previous and/or subsequent Figures and/or description thereof. Of course, however, the embedding system 200 may be implemented in the context of any desired environment. Further, the aforementioned definitions may equally apply to the description below.

It is to be understood that the items, elements, and features of FIG. 2 are presented solely as exemplary in nature. Other modifications and integration of other items, elements, and features are envisioned and possible.

The embedding system 200 includes an embedding layer 202 and an input layer 204. The embedding layer 202 comprises a document encoder 206, an interaction encoder 208, a payer encoder 210, and a vendor encoder 212. The input layer 204 includes a document features module 214, an interaction features module 216, a payer features module 218, and a vendor features module 220.

In some cases, the document features module 214 may extract textual information from documents. The document features module 214 may analyze positional information of text fields within the documents. Additionally, the document features module 214 may capture visual information including logos, font sizes, and table designs.

Additionally, the document features module 214 may process a wide range of characteristics from input documents to generate comprehensive embeddings. This module may analyze textual content (TEXT) and visual elements (IMAGE) within the document. It may also consider structural attributes such as PAGE SIZE, ASPECT RATIO, and the number of pages (Num_of_pages). The module may examine color information (COLOR) and assess the document's type (DOCTYPE), which could include categories like invoices, receipts, statements, contracts, or tax forms. File metadata, including information about the software that generated the file (FILE_METADATA), may be incorporated into the analysis. The module may determine whether the document is digital (IS_DIGITAL) and evaluate its visual quality through measures like BLURRINESS or Laplacian variance. Textual analysis may include WORD COUNTS and LINE COUNTS, while spatial analysis may involve assessing QUADRANT DENSITY. The module may identify the LANGUAGE of the document and process logo information through LOGOLENGS EMBEDDING. Additionally, it may generate a multi-task learning (MTL) embedding to capture various document attributes simultaneously. By processing this diverse set of features, the document features module 214 may create rich, multifaceted embeddings that capture both the content and structure of input documents.

The document encoder 206 may use a transformer architecture to process the textual, visual, and/or positional information provided by the document features module 214. In one embodiment, the transformer architecture may be LayoutLM. In another embodiment, the document encoder 206 may locate logos within the documents and determine logo representations using convolutional neural networks, etc.

In some aspects, the techniques described herein relate to a system, wherein the transformer architecture may include various types of transformer models, such as bi-directional transformers, LayoutLM, models designed for document layout analysis, decoder-only transformers, encoder-only transformers, or encoder-decoder transformers. The system may utilize different transformer architectures depending on the specific requirements of the task, potentially incorporating models like BERT, GPT, T5, or other advanced language models. These architectures may be pre-trained on large corpora and fine-tuned for specific document understanding tasks, or custom-trained on domain-specific data. The choice of architecture may be influenced by factors such as the nature of the input data, the desired output, computational resources, and the need for contextual understanding or generative capabilities. The system may also employ hybrid approaches that combine multiple transformer types or integrate transformers with other neural network architectures to optimize performance for processing textual, positional, and potentially visual information in documents.

The interaction features module 216 may analyze various aspects of payor-vendor interactions. In some cases, the interaction features module 216 may analyze payment frequency between payers and vendors, payment amounts and dates, bill descriptions, line items, and expense and approver chains.

Additionally, the interaction features module 216 may analyze various aspects of how people interact with documents and the relationships between entities in the vendor-payor network. This module may examine the BEHAVIOR OF PEOPLE DEALING WITH THE DOCUMENT, which could include patterns of access, editing, or approval processes. It may also consider the dual roles entities can play in the network, such as determining if a vendor is also a payer (IS VENDOR A PAYER?). The module may employ sophisticated FIELD EXTRACTION techniques to glean structured information from documents. For example, this extraction process may utilize repeated model features to improve accuracy and consistency across similar document types. Additionally, it may leverage the surrounding context of previous ground truth (GT) data to enhance the extraction of new fields. By incorporating these behavioral and contextual elements, the interaction features module 216 may generate embeddings that capture not just the static content of documents, but also the dynamic ways in which they are used and interpreted within the vendor-payor network. This rich contextual information may enable the system to provide more nuanced and relevant recommendations based on both document content and usage patterns.

The payer features module 218 may process payer-specific information. In some cases, the payer features module 218 may analyze payer business information, account software usage, login information, transaction behaviors, and payment trends.

In various embodiments, the payer features module 218 may process a comprehensive set of attributes related to payers in the vendor-payor network. This module may analyze fundamental business information (such as but not limited to the payer's NAME and ADDRESS, as well as their BUSINESS CATEGORY), which may be represented by a standardized classification like the NAICS CODE. The module may consider the COMPANY SIZE, which could influence payment behaviors and vendor relationships. It may also incorporate data on PAYMENT PREFERENCE, if available, to understand the payer's preferred methods or terms for transactions. The module may assess the payer's financial activity through metrics such as ANNUAL TPV (Total Payment Volume) SIZE and TRANSACTION VOLUME, providing insights into the scale and frequency of their payments. To maintain consistency in identification across different interactions or data sources, the module may utilize a PERSISTENTID or PRECLUSTER ID. Additionally, the module may incorporate a RISK SCORE, which could be derived from various factors and used to assess the reliability or creditworthiness of the payer.

The vendor features module 220 may process vendor-specific information. In some cases, the vendor features module 220 may analyze vendor information created by payers, invoice documents sent to payers, and payment methods accepted by vendors.

In various embodiments, the vendor features module 220 may process a comprehensive set of attributes related to vendors in the vendor-payor network. This module may analyze fundamental business information such as the vendor's NAME and ADDRESS, as well as their BUSINESS CATEGORY, which may be represented by a standardized classification like the NAICS CODE. The module may consider the COMPANY SIZE, which could influence their capacity and service offerings. It may also incorporate data on PAYMENT PREFERENCE, including whether the vendor accepts various payment methods such as virtual cards (VCARD), electronic ACH transfers (eACH), IT payments, IPFX, or other forms (IF). The module may assess the vendor's financial activity through metrics such as ANNUAL TPV (Total Payment Volume) SIZE and TRANSACTION VOLUME, providing insights into the scale and frequency of payments they receive. To maintain consistency in identification across different interactions or data sources, the module may utilize a PERSISTENTID or PRECLUSTER ID. Additionally, the module may incorporate a RISK SCORE, which could be derived from various factors and used to assess the reliability or creditworthiness of the vendor.

The document encoder 206, interaction encoder 208, payer encoder 210, and/or vendor encoder 212 may process the information provided by their respective features modules in the input layer 204. The encoders in the embedding layer 202 may work together to generate multimodal embeddings that represent different aspects of the vendor-payor network entities.

The embedding system 200 enables the generation of comprehensive multimodal embeddings by processing various types of data related to documents, interactions, payers, and vendors. These multimodal embeddings may be used in subsequent steps of the method 100 (or in other aspects per the other FIGs. provided), such as storing in a vector database, retrieving in response to queries, and generating business recommendations.

In various embodiments, it is to be appreciated that the ability to generate comprehensive multimodal embeddings by processing various types of data (related to documents, interactions, payers, and vendors) addresses several key challenges in managing vendor-payor relationships. By incorporating diverse data types, the system may overcome the limitations of traditional methods that often rely on single-modal or limited data sources. This comprehensive approach may enable more accurate representation of the complex, multifaceted nature of vendor-payor relationships. Additionally, the ability to process document features, including both textual and visual elements, may improve the accuracy of document classification and information extraction, addressing the challenge of efficiently managing large volumes of diverse documents. By analyzing interaction data, the system may capture the dynamic aspects of vendor-payor relationships, potentially revealing patterns and trends that static data alone might miss.

Further, in other embodiments, the inclusion of payer and vendor-specific features may allow for more nuanced understanding of each entity's characteristics and behaviors, enabling more personalized and relevant recommendations. This multimodal approach may also enhance the system's ability to handle complex queries that span multiple data types, addressing the challenge of retrieving relevant information from large, diverse datasets.

As such, by generating embeddings that encapsulate this rich, multidimensional data, the system disclosed herein improves upon traditional systems and may provide a more holistic view of vendor-payor networks, potentially leading to more informed decision-making, improved relationship management, and more accurate predictions and recommendations.

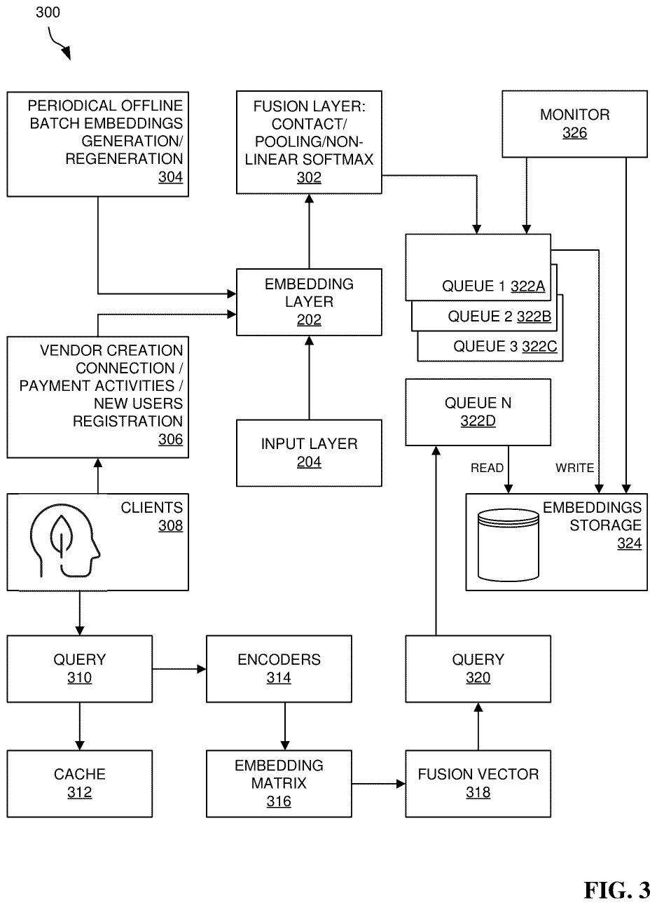

FIG. 3 illustrates a system architecture 300 for generating and processing multimodal embeddings, in accordance with one embodiment. As an option, the system architecture 300 may be implemented in the context of any one or more of the embodiments set forth in any previous and/or subsequent Figures and/or description thereof. Of course, however, the system architecture 300 may be implemented in the context of any desired environment. Further, the aforementioned definitions may equally apply to the description below.

The system architecture 300 includes a batch processor 304 that performs periodical offline batch embeddings as it relates to generation and regeneration. The batch processor 304 connects to the embedding layer 202, which processes the embeddings. The embedding layer 202 receives input from the input layer 204, as discussed hereinabove within the context of FIG. 2.

A registration module 306 handles vendor creation, connection, payment activities, and/or new user registration. The registration module 306 interfaces with a client interface 308 that allows users to interact with the system architecture 300.

In various embodiments, the client interface 308 may serve as a primary point of interaction for users within the system, capturing a wide range of user activities and inputs. These interactions may include queries, data updates, feedback on recommendations, and various other user-driven actions. As users engage with the system through the client interface 308, it may generate valuable data about user preferences, behavior patterns, and specific needs within the vendor-payor network.

Additionally, this user interaction data from the client interface 308 may then flow into the registration module 306. The registration module 306 may use this information to enrich and update existing entity profiles, create new connections between entities, or trigger the creation of new entities based on user actions. For instance, if a user frequently searches for a particular type of vendor through the client interface 308, the registration module 306 may update the user's profile to reflect this preference or potentially suggest new vendor registrations. Further, the registration module 306 may process and structure this enriched data, combining it with existing information about vendors, payers, and their interactions. It may apply business rules, perform data validation, and ensure consistency across the system. This processed data may then be passed to the embedding layer 202, as has been discussed hereinabove.

The embedding layer 202 may use this continually updated and enriched data from the registration module 306 to generate and refine multimodal embeddings. These embeddings may incorporate not just static entity information, but also dynamic user interaction patterns and preferences captured through the client interface 308. For example, the embedding layer 202 may adjust the weights of certain features in the embeddings based on observed user behaviors, or it may create new dimensions in the embedding space to represent emerging patterns of interaction.

This flow from client interface 308 through registration module 306 to embedding layer 202 may enable the system to create more personalized and context-aware embeddings. It may allow the system to adapt its representations based on actual usage patterns and user needs, potentially improving the relevance and accuracy of recommendations and analyses.

Additionally, the client interface 308 connects to a query processor 310 and a cache module 312. In various embodiments, the query processor 310 may be configured for interpreting and executing user queries efficiently. It may analyze incoming queries, break them down into constituent parts, and/or formulate a strategy for retrieving relevant information from the system's databases and embedding spaces. As such, the query processor 310 may employ advanced natural language processing techniques to understand the intent behind user queries, even when they are complex or ambiguous. It may also optimize query execution by determining the most efficient order of operations, selecting appropriate indexes, and utilizing parallel processing when possible. The query processor 310 may convert queries into a format compatible with the multimodal embedding space, enabling semantic search capabilities that go beyond simple keyword matching.

In various embodiments, the cache module 312 may function as a high-speed data storage layer designed to improve system performance and reduce latency in query responses. It may store frequently accessed data, including popular query results, commonly used embeddings, and/or recently updated entity information, in a quickly accessible format. The cache module 312 may implement sophisticated caching strategies, such as least recently used (LRU) or adaptive replacement cache (ARC), to optimize memory usage and ensure that the most relevant data is always readily available. It may also employ intelligent prefetching algorithms to anticipate user needs and cache data proactively. The cache module 312 may work in close coordination with the query processor 310, providing rapid access to cached results for common queries and reducing the load on the main storage systems. This caching mechanism may significantly enhance the system's responsiveness, particularly for repetitive queries or in scenarios with high concurrent user access.

The query processor 310 feeds into an encoder module 314 which generates an embedding matrix 316. In some cases, the query processor 310 may convert the query into a multimodal embedding tensor. The query processor 310 may perform a k-nearest neighbor search across distributed shards. Additionally, the query processor 310 may apply a merge sort algorithm to aggregate query results from distributed instances.

In various embodiments, the encoder module 314 may be responsible for transforming various types of input data into dense vector representations suitable for further processing and analysis. This encoder module 314 may employ advanced machine learning techniques, such as deep neural networks or transformer architectures, to encode complex, high-dimensional data into more compact and semantically meaningful embeddings. Additionally, the encoder module 314 may be capable of handling diverse data types, including textual information, numerical features, categorical variables, and potentially even visual or audio data, depending on the specific requirements of the vendor-payor network analysis. It may apply different encoding strategies for different types of input, such as using pre-trained language models for text data or convolutional neural networks for image processing. The encoder module 314 may also implement techniques like transfer learning to leverage knowledge from pre-trained models and adapt them to the specific domain of vendor-payor relationships.

In various embodiments, the embedding matrix 316 generated by the encoder module 314 may represent a structured collection of these encoded vectors, organized in a way that facilitates efficient retrieval and comparison operations. This matrix may contain rows corresponding to different entities, documents, or interactions within the vendor-payor network, with each row representing a multidimensional embedding that captures the salient features and relationships of that item. In one embodiment, the dimensions of the embedding matrix 316 may be carefully optimized to balance between representational power and computational efficiency.

In another embodiment, the embedding matrix 316 may serve as a compact, information-rich representation of the entire vendor-payor network, enabling rapid similarity calculations, clustering analyses, and other advanced operations. It may be dynamically updated as new data is processed by the encoder module 314, ensuring that it always reflects the most current state of the network. The structure of the embedding matrix 316 may also be designed to facilitate efficient querying and retrieval, potentially incorporating indexing schemes or other optimizations to enhance performance in large-scale applications.

The embedding matrix 316 connects to a fusion vector 318 which then feeds into a query engine 320.

In various embodiments, the fusion vector 318 may serve as a consolidated representation that combines information from various sources and modalities within the system. This vector may be created by integrating different types of embeddings, such as those derived from document features, interaction patterns, payer characteristics, and vendor attributes. The fusion process may involve sophisticated techniques like attention mechanisms, weighted averaging, or neural network-based fusion methods to optimally combine these diverse inputs. The fusion vector 318 may capture complex relationships and interdependencies between different aspects of the vendor-payor network, potentially revealing insights that might not be apparent when considering each data source in isolation. This integrated representation may adapt dynamically based on the specific query context or user preferences, emphasizing different aspects of the fused information as needed.

The query engine 320 may be used to leverage the rich information encapsulated in the fusion vector 318 to process and respond to user queries efficiently and accurately. It may employ advanced algorithms to interpret the query intent, match it against the multidimensional space represented by the fusion vector, and retrieve the most relevant results. The query engine 320 may utilize techniques such as semantic similarity matching, nearest neighbor search in high-dimensional spaces, and/or graph-based traversal algorithms to identify the most pertinent information. It may also incorporate machine learning models that can learn from user interactions and feedback to improve the relevance of query results over time. As such, the query engine 320 may be configured to handle complex, multi-faceted queries that span different aspects of the vendor-payor relationship, potentially offering capabilities like query expansion, faceted search, or interactive query refinement. By operating on the comprehensive fusion vector 318, the query engine 320 may provide more nuanced and context-aware responses, taking into account the intricate relationships and patterns within the vendor-payor network. In various embodiments, the query engine 320 may be in a format of a vector, while the query processor 310 may include a raw query in any format of text/image etc.

The system architecture 300 includes multiple queues (a first queue 322A, a second queue 322B, a third queue 322C, through an nth queue 322D) that manage the flow of data to and from a storage database 324. The storage database 324 handles both read and write operations for the storage of the embeddings. In some cases, the storage database 324 may compress the embeddings to reduce storage requirements. The storage database 324 may store metadata alongside the embeddings. Additionally, the storage database 324 may shard the embeddings across multiple nodes for parallel processing. The storage database 324 may cache frequently accessed embeddings to reduce retrieval time.

In various embodiments, the storage database 324 may serve as a central repository for the multimodal embeddings and associated metadata within the system. For write operations, the storage database 324 may employ efficient algorithms to compress the high-dimensional embedding vectors, reducing storage requirements while preserving the essential information content. It may implement sophisticated indexing structures, such as locality-sensitive hashing or hierarchical navigable small world graphs, to enable fast insertion of new embeddings. The write process may also involve updating metadata associated with each embedding, such as timestamps, version information, or usage statistics. To handle high write volumes, the storage database 324 may utilize techniques like write-ahead logging or batch processing to optimize performance and ensure data integrity. In one embodiment, the write command may originate from any of the queues 322A-322C.

For read operations, the storage database 324 may employ advanced retrieval mechanisms to quickly access relevant embeddings based on query parameters. It may utilize the indexing structures created during the write process to perform efficient similarity searches in the high-dimensional embedding space. The read process may involve decompressing the stored embeddings on-the-fly, potentially using hardware acceleration for improved performance. To enhance read speeds, the storage database 324 may implement caching strategies, keeping frequently accessed embeddings in faster memory tiers. It may also support parallel read operations, distributing queries across multiple nodes or shards to handle high concurrency. The read process may include access control mechanisms to ensure data security and privacy, allowing retrieval only for authorized users or processes. In one embodiment, the read command may originate from the Nth queue 322D (in response to query engine 320).

A monitor module 326 oversees the queues and storage operations. The monitor module 326 may use multiple techniques for efficient indexing and storage, including compression, metadata storage, sharding, caching, and database/index tuning.

In various embodiments, the monitor module 326 may serve as a comprehensive oversight system for the entire embedding storage and retrieval process. It may continuously track and analyze various performance metrics across the system, including write and read latencies, compression ratios, cache hit rates, query response times, etc. The monitor module 326 may implement sophisticated anomaly detection algorithms to identify potential issues or performance bottlenecks in real-time.

Further, the monitor module 326 may use machine learning techniques to predict future system load and proactively adjust resources or storage strategies to maintain optimal performance. The monitor module 326 may provide detailed logging and tracing capabilities, allowing for in-depth analysis of system behavior and facilitating quick troubleshooting of any issues. Additionally, the monitor module 326 may also offer a dashboard interface for system administrators, providing visualizations of key performance indicators and allowing for manual tuning of system parameters. The monitor module 326 may implement automated optimization routines, such as dynamically adjusting cache sizes, rebalancing data across shards, or triggering index rebuilds based on observed usage patterns. The monitor module 326 may also coordinate with other system components to ensure data consistency and integrity, particularly during operations like data migration or system upgrades.

A fusion layer 302 performs various tasks on incoming data (including contact, pooling, and/or non-linear softmax operations on the data). For example, the fusion layer 302 may operate at a fundamental level, performing initial integration of diverse data types as they enter the system from the embedding layer 202. The fusion layer 302 may apply contact, pooling, and non-linear softmax operations to combine and normalize inputs from various sources. This fusion layer 302 may work on raw or partially processed data, handling the initial stages of feature extraction and combination. The fusion layer 302 may be responsible for creating a unified representation from heterogeneous inputs, potentially dealing with challenges such as different data scales, missing values, or inconsistent formats. It may employ techniques like multi-head attention mechanisms or cross-modal transformers to capture complex relationships between different data modalities. In one embodiment, the fusion layer 302 and the fusion vector 318 may each include similar or the same operations and/or functions on all sub-type embeddings.

Additionally, the interaction between the input layer 204, embedding layer 202, and fusion layer 302 represents a sophisticated data processing pipeline within the system architecture. The input layer 204 may serve as the initial point of entry for diverse data types related to vendor-payor networks, including document features, interaction data, payer information, and vendor details. This input layer 204 may preprocess and structure the incoming data, preparing it for further analysis.

The preprocessed data from the input layer 204 then flows into the embedding layer 202, where it undergoes transformation into high-dimensional vector representations. The embedding layer 202 may employ various encoding techniques tailored to different data types, such as transformer models for text data or convolutional neural networks for visual information, to generate rich, semantically meaningful embeddings. These embeddings capture the essential characteristics and relationships within the data.

The output from the embedding layer 202 is then passed to the fusion layer 302, which integrates the various embeddings into a unified representation. The fusion layer 302 may apply techniques such as attention mechanisms, pooling operations, and non-linear transformations to combine the different embedding types effectively. This layer may also incorporate contextual information or query-specific parameters to create a more relevant and comprehensive fused representation. The unified representation resulting from the fusion layer 302 may then be passed to the queues (first queue 322A, second queue 322B, third queue 322C) for subsequent storage in the storage database 324.

The system architecture 300 may be distributed over multiple instances with multiple shards and replicas, enabled on multiple zones. In some cases, the system architecture 300 may use autoscaling to handle increased load on the service.

The components of the system architecture 300 may be arranged in a hierarchical structure with data flowing from the input layers through processing stages to storage and querying capabilities. The system architecture 300 may enable both batch processing of embeddings through the batch processor 304, and/or real-time querying through the client interface 308.

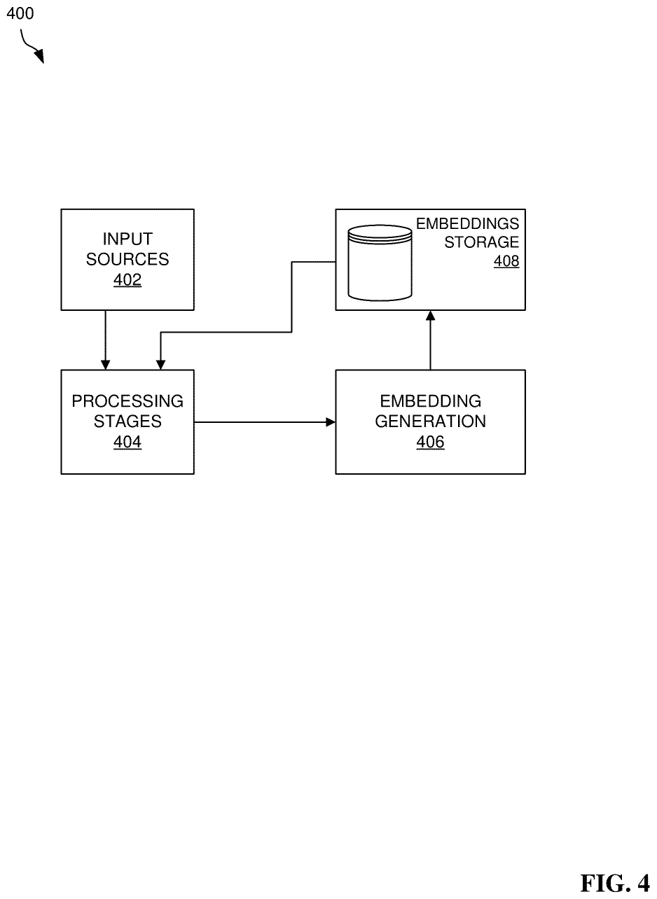

FIG. 4 illustrates a block diagram of an embedding system 400 for generating and storing multimodal embeddings, in accordance with one embodiment. As an option, the embedding system 400 may be implemented in the context of any one or more of the embodiments set forth in any previous and/or subsequent Figures and/or description thereof. Of course, however, the embedding system 400 may be implemented in the context of any desired environment. Further, the aforementioned definitions may equally apply to the description below.

The embedding system 400 includes an input module 402, a processing module 404, an embedding module 406, and a storage module 408. The input module 402 may receive input data from various sources, such as documents, payor-vendor network interactions, payer information, vendor information, user interaction, etc. The input module 402 may connect to the processing module 404 through multiple paths, allowing for different types of input data to be processed separately.

The processing module 404 may process the received input data from the input module 402. In some cases, the processing module 404 may use visual transformers to create embeddings for both text and image simultaneously. This approach may allow the embedding system 400 to capture both textual and visual information in a unified representation.

The embedding module 406 may generate embeddings based on the processed input data from the processing module 404. In some cases, the embedding module 406 may use a combination of concatenation, weighted average, and shallow fusion neural network to combine different types of embeddings. This approach may allow the embedding system 400 to create comprehensive multimodal embeddings that capture various aspects of the vendor-payor network entities.

The storage module 408 may store the generated embeddings from the embedding module 406 in a database structure. In some cases, the storage module 408 may determine the optimal dimensionality for each type of embedding through offline optimization. This optimization process may help balance the trade-off between embedding expressiveness and storage efficiency.

The connections between modules in the embedding system 400 are shown as directional arrows, indicating the flow of data through the system from input to storage. This flow may allow for efficient processing and storage of multimodal embeddings, which may be used in subsequent steps of the method 100, such as retrieving embeddings in response to queries and generating business recommendations.

The embedding system 400 may work in conjunction with other components of the system architecture 300, such as the batch processor 304 for periodical offline batch embeddings generation and the storage database 324 for efficient indexing and storage of the generated embeddings. By generating and storing comprehensive multimodal embeddings, the embedding system 400 may contribute to more accurate and relevant recommendations for vendor-payor network entities.

Additionally, it is be understood that FIG. 4 presents a more simplified and abstracted representation of the data processing flow compared to the detailed architecture shown in FIG. 3. The input module 402 in FIG. 4 may be seen as a condensed version of the various input sources and the input layer 204 from FIG. 3, encompassing the initial data ingestion and preprocessing stages. The processing module 404 in FIG. 4 may correspond to a combination of several components from FIG. 3, including aspects of the embedding layer 202, the batch processor 304, and potentially parts of the query processor 310. The processing module 404 may represent the general data transformation and analysis stage.

The embedding module 406 in FIG. 4 may be viewed as a simplified representation of the embedding layer 202 and the fusion layer 302 from FIG. 3, focusing on the core function of generating embeddings. Finally, the storage module 408 in FIG. 4 may correspond to the storage database 324 and associated queues (322A-D) from FIG. 3, representing the data storage and retrieval functionality in a more abstract manner.

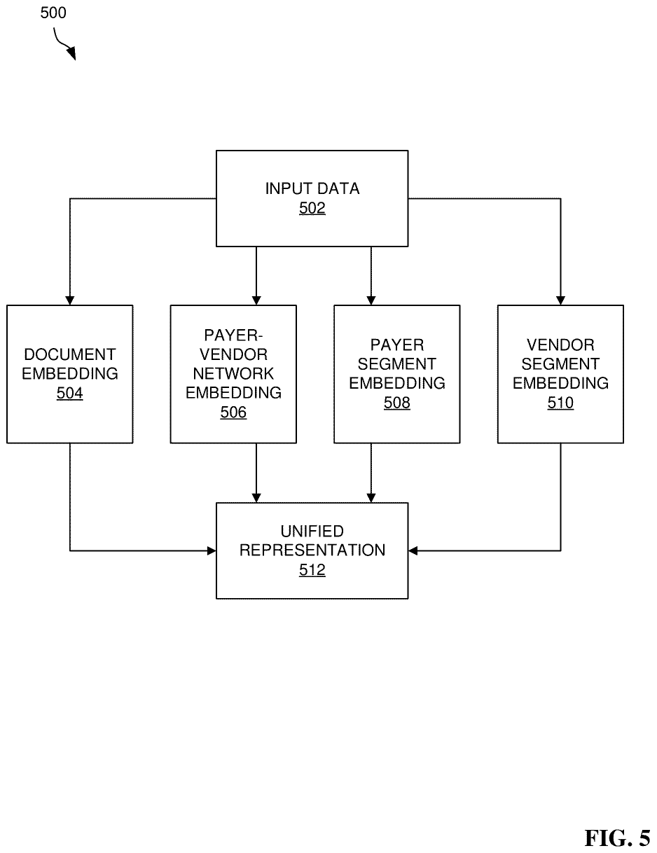

FIG. 5 illustrates a block diagram of an embedding system 500 for generating multimodal embeddings, in accordance with one embodiment. As an option, the embedding system 500 may be implemented in the context of any one or more of the embodiments set forth in any previous and/or subsequent Figures and/or description thereof. Of course, however, the embedding system 500 may be implemented in the context of any desired environment. Further, the aforementioned definitions may equally apply to the description below.

The embedding system 500 includes an input module 502 that receives input data and distributes it to multiple parallel processing paths. The input module 502 may receive various types of data related to vendor-payor network entities, including document information, network interaction data, payer information, and vendor information.

Connected to the input module 502 are four separate embeddings: a document embedding 504, a network embedding 506, a payer embedding 508, and a vendor embedding 510. Each embedding is designed to handle a specific aspect of the input data. Additionally, in one embodiment, each of the embeddings may include one or more processors configured to process the input data from the input module 502.

The document embedding 504 may generate document embeddings based on the textual and visual information from input documents. In some cases, the document embedding 504 may utilize techniques similar to those employed by the document encoder 206 in the embedding system 200.

The network embedding 506 may generate payer-vendor network embeddings by analyzing interaction data between payers and vendors. The network embedding 506 may process information such as payment frequencies, amounts, and patterns, similar to the functionality of the interaction encoder 208.

The payer embedding 508 may generate payer segment embeddings by processing payer-specific information. In some cases, the payer embedding 508 may analyze data similar to that handled by the payer encoder 210, including business information, account usage, and transaction behaviors.

The vendor embedding 510 may generate vendor segment embeddings by processing vendor-specific information. The vendor embedding 510 may analyze data similar to that handled by the vendor encoder 212, such as vendor information created by payers and accepted payment methods.

The outputs from all four embedding are directed to an embedding generator 512. The embedding generator 512 may combine the individual embeddings into a unified representation. In some cases, the embedding generator 512 may use techniques such as concatenation, weighted averaging, or shallow fusion neural networks to create the final multimodal embedding.

The parallel processing structure of the embedding system 500 allows for efficient handling of different types of input data simultaneously. This approach may enable the embedding system 500 to process large volumes of data more quickly than a sequential processing system.

In some cases, the embedding system 500 may handle seasonal or temporal variations in payor-vendor interactions when generating embeddings. The network embedding 506 may incorporate time-based features into the network embeddings, allowing the system to capture patterns that change over time. For example, the network embedding 506 may analyze payment frequencies and amounts in relation to specific time periods or seasons, enabling the embedding system 500 to generate embeddings that reflect these temporal variations.

The embedding system 500 may work in conjunction with other components of the system architecture 300, such as the batch processor 304 for periodical offline batch embeddings generation, and/or the storage database 324 for efficient storage of the generated embeddings. By leveraging parallel processing and incorporating temporal aspects, the embedding system 500 may contribute to more comprehensive and accurate representations of vendor-payor network entities, potentially leading to improved business recommendations and insights.

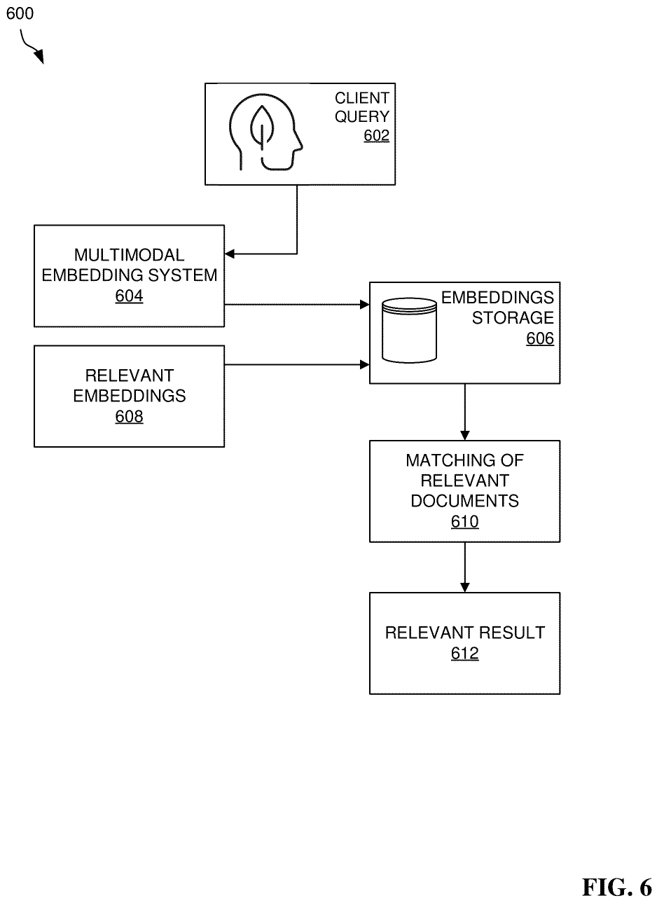

FIG. 6 illustrates a system architecture 600 for generating and matching multimodal embeddings, in accordance with one embodiment. As an option, the system architecture 600 may be implemented in the context of any one or more of the embodiments set forth in any previous and/or subsequent Figures and/or description thereof. Of course, however, the system architecture 600 may be implemented in the context of any desired environment. Further, the aforementioned definitions may equally apply to the description below.

The system architecture 600 includes a query interface 602, an multimodal embedding system 604, an embeddings storage 606, an embedding retrieval module 608, a matching processor 610, and a results interface 612. These components work together to process queries, retrieve relevant embeddings, and present matched results.

A query interface 602 may receive input queries from users. The query interface 602 may connect to a multimodal embedding system 604, which may process the input queries and generate multimodal embeddings. In some cases, the multimodal embedding system 604 may utilize techniques similar to those employed by the embedding system 200 to generate comprehensive multimodal embeddings.

The multimodal embedding system 604 may communicate with an embeddings storage 606 that may store the generated embeddings. The embeddings storage 606 may provide efficient storage and retrieval capabilities for the high-dimensional embedding vectors, similar to the storage database 324 in the system architecture 300.

An embedding retrieval module 608 may access the embeddings storage 606 to retrieve relevant embeddings based on the query. In some cases, the embedding retrieval module 608 may perform operations similar to those of the query processor 310 in the system architecture 300, such as converting the query into a multimodal embedding tensor and performing a k-nearest neighbor search across distributed shards.

The retrieved embeddings may then be processed by a matching processor 610 that may perform matching operations on the relevant documents. The matching processor 610 may calculate similarity scores between the query embedding and retrieved embeddings. In some cases, the matching processor 610 may use cosine similarity to calculate these similarity scores. The matching processor 610 may then order the results based on the calculated similarity scores.

The matching processor 610 may forward the processed results to a results interface 612, which may present the matched results to the user. The results interface 612 may provide a user-friendly display of the matched and ranked results, allowing users to easily interpret and act upon the recommendations generated by the system architecture 600.

The components of the system architecture 600 may be arranged in a sequential flow, with data moving from the query interface 602 through the processing stages to the final results interface 612. This arrangement may enable efficient processing and matching of multimodal embeddings through the interconnected components.

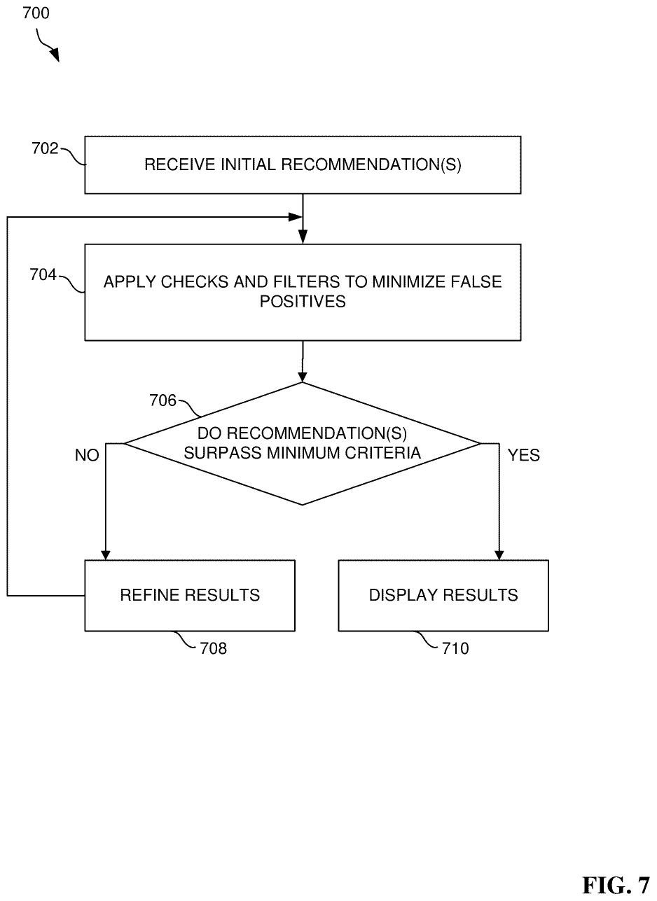

FIG. 7 illustrates a flowchart of a recommendation filtering process 700, in accordance with one embodiment. As an option, the recommendation filtering process 700 may be implemented in the context of any one or more of the embodiments set forth in any previous and/or subsequent Figures and/or description thereof. Of course, however, the recommendation filtering process 700 may be implemented in the context of any desired environment. Further, the aforementioned definitions may equally apply to the description below.

The recommendation filtering process 700 begins with a step 702 of receiving initial recommendation(s). These initial recommendations may be generated by the embedding system based on multimodal embeddings of vendor-payor network entities.

Following the receipt of initial recommendations, the recommendation filtering process 700 proceeds to a step 704 of applying checks and filters to minimize false positives. In some cases, the embedding system may apply a machine learning model trained on known information about documents, payment patterns, and payer-vendor preferences. In one embodiment, the machine learning model may be optimized using an F1 score to balance precision and recall, ensuring that the filtering process effectively reduces false positives while maintaining a high level of relevant recommendations.

After applying the checks and filters, the recommendation filtering process 700 moves to a decision block 706. At the decision block 706, the process evaluates whether the recommendation(s) surpass minimum criteria. These criteria may be based on various factors, including similarity scores, relevance metrics, and/or confidence levels derived from the machine learning model.

If the recommendation(s) do not surpass the minimum criteria, the recommendation filtering process 700 proceeds to a step 708 of refining the results. In some cases, the refining process may involve adjusting the parameters of the machine learning model, incorporating additional contextual information, an/oror applying more stringent filtering criteria. After refining the results, the process loops back to step 704 for further filtering.

If the recommendation(s) do surpass the minimum criteria, the recommendation filtering process 700 advances to a step 710 of displaying the results. The displayed results may represent the final, filtered recommendations that have passed through multiple iterations of checks and refinements. In one embodiment, the embedding system may inference upon historical payer-vendor behaviors and trends to further refine and personalize the recommendations.

As part of the filtering process, the embedding system may also detect duplicate documents. In some cases, the embedding system may generate document text embeddings from optical character recognition and create document entity recognition embeddings. The embedding system may then compare similarities between input embeddings and existing embeddings to identify potential duplicates, further enhancing the quality and relevance of the recommendations.

By implementing the recommendation filtering process 700, the embedding system may ensure that the final recommendations presented to users are of high quality, minimizing false positives and providing relevant, personalized results based on comprehensive analysis of vendor-payor network entities and their interactions.

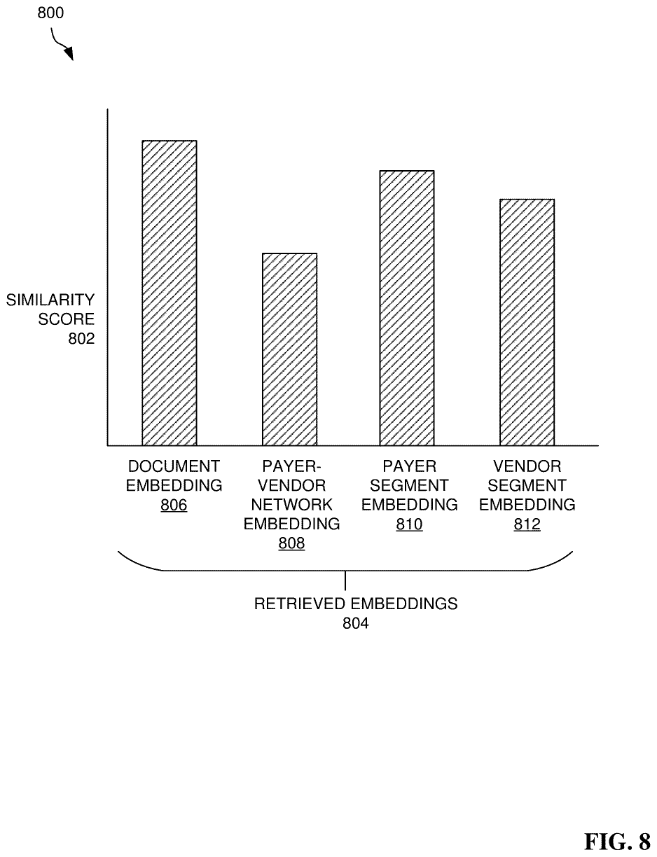

FIG. 8 illustrates a similarity graph 800 showing relative similarity scores for different types of embeddings, in accordance with one embodiment. As an option, the similarity graph 800 may be implemented in the context of any one or more of the embodiments set forth in any previous and/or subsequent Figures and/or description thereof. Of course, however, the similarity graph 800 may be implemented in the context of any desired environment. Further, the aforementioned definitions may equally apply to the description below.

The similarity graph 800 includes a similarity score axis 802 that extends vertically and measures the similarity values for retrieved embeddings 804. The retrieved embeddings 804 comprise a document embedding 806, a payer-vendor network embedding 808, a payer segment embedding 810, and a vendor segment embedding 812.

In the similarity graph 800, the document embedding 806 shows the highest similarity score among the retrieved embeddings 804. The payer segment embedding 810 and vendor segment embedding 812 display intermediate similarity scores, while the payer-vendor network embedding 808 exhibits the lowest similarity score among the retrieved embeddings 804.

The relative positions of the different types of embeddings on the similarity graph 800 may provide insights into the matching process performed by the matching processor 610. In some cases, the matching processor 610 may use the similarity scores represented in the similarity graph 800 to rank and prioritize different types of embeddings when generating recommendations.

The system architecture 600 may use multiple performance metrics to evaluate the effectiveness of the matching process and the resulting recommendations. In some cases, these metrics may include Recall@1, Recall@3, Precision, F1, ROC (Receiver Operating Characteristic), and NDCG (Normalized Discounted Cumulative Gain). These metrics may be calculated based on the similarity scores represented in the similarity graph 800.

For example, the Recall@1 and Recall@3 metrics may measure how often the most relevant embedding (as determined by the highest similarity score) is included in the top one or top three recommendations, respectively. The Precision metric may indicate the proportion of recommended embeddings that are relevant, while the F1 score may provide a balanced measure of precision and recall.

The ROC metric may be used to evaluate the system's ability to distinguish between relevant and irrelevant embeddings across different similarity score thresholds. The NDCG metric may assess the quality of the ranking of the retrieved embeddings 804, taking into account the position of each embedding in the ranked list.

By analyzing the similarity graph 800 and calculating these performance metrics, the system architecture 600 may continuously evaluate and improve the effectiveness of the multimodal embedding matching process. This evaluation may inform adjustments to the embedding generation process performed by the embedding system 200 or the matching algorithms used by the matching processor 610, ultimately leading to more accurate and relevant business recommendations.

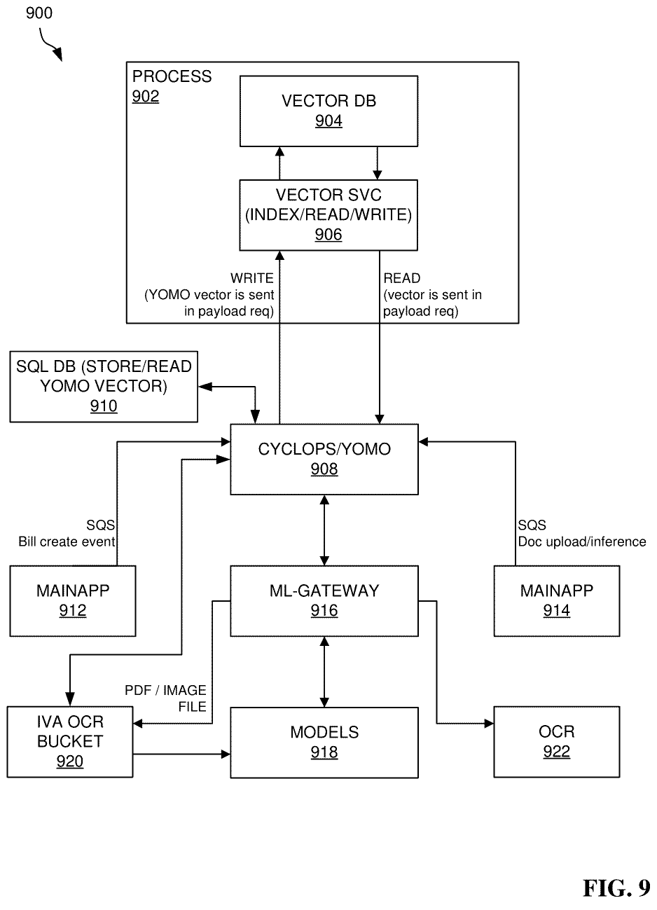

FIG. 9 illustrates a system architecture 900 for processing and managing vector data, in accordance with one embodiment. As an option, the system architecture 900 may be implemented in the context of any one or more of the embodiments set forth in any previous and/or subsequent Figures and/or description thereof. Of course, however, the system architecture 900 may be implemented in the context of any desired environment. Further, the aforementioned definitions may equally apply to the description below.

As shown, the system architecture 900 includes a process module 902 that contains a vector database 904 and a vector service module 906. The vector service module 906 may perform index, read, and write operations with the vector database 904. In some cases, the vector service module 906 may handle write operations where vector data is sent in payload requests to the vector database 904 originating from the processing engine 908. The vector service module 906 may also manage read operations where vector data is retrieved from the vector database 904 in response to payload requests from the processing engine 908. This bidirectional flow of data may allow for dynamic updates and retrieval of vector information within the system architecture 900, and specifically within the process module 902. In one embodiment, the processing engine 908 and the SQL database 910 may include YoMo context internal vector engine, Cyclops (vector-based data processing), etc.

Additionally, the system architecture 900 includes a processing engine 908 that interfaces with multiple components. For example, the processing engine 908 may serve as a central hub for coordinating operations between various modules and databases. In some cases, the processing engine 908 may implement load balancing techniques to distribute processing tasks across multiple nodes or instances.

The processing engine 908 connects to an SQL database 910 that may store and read vector data. The SQL database 910 may provide structured storage capabilities for vector data, complementing the vector-specific storage provided by the vector database 904.

A first application module 912 may communicate with the processing engine 908 through SQS bill create events, and a second application module 914 may communicate with the processing engine 908 through SQS document upload/inference events. These application modules may represent different entry points or use cases for vector data processing within the system architecture 900.

In some cases, the first application module 912 may handle bill creation events, generating vector representations of billing information. The second application module 914 may process document uploads and perform inference tasks on the uploaded documents, potentially leveraging the vector representations stored in the system.

A gateway module 916 may interface between the processing engine 908 and a model database 918. The gateway module 916 may facilitate secure and controlled access to the machine learning models stored in the model database 918. Additionally, a storage bucket 920 may be used to process PDF and image files. In one embodiment, the storage bucket 920 may serve as a repository for raw document data. In some cases, the storage bucket 920 may implement compression techniques to optimize storage utilization for large document files. Further, the storage bucket 920 may also employ encryption methods to ensure the security of sensitive document information stored within the system.

A recognition module 922 may perform optical character recognition operations. For example, the recognition module 922 may extract textual information from image-based documents, enabling the conversion of unstructured visual data into structured text that can be processed and vectorized by other components of the system. In some cases, the recognition module 922 may employ advanced machine learning techniques, such as deep learning-based OCR models, to improve the accuracy of text extraction from complex document layouts or low-quality images.

In various embodiments, the system may use datadog/kibana for monitoring accuracy and latency. These monitoring tools may provide real-time insights (including but not limited to processing speed, error rates, resource utilization, etc.) into the performance and reliability of various components within the system architecture 900. In some cases, the monitoring capabilities provided by datadog/kibana may be integrated with automated alerting systems. These systems may notify administrators of potential performance bottlenecks or anomalies, which in turn may enable proactive maintenance.

In various embodiments, vector write operations may occur during bill creation, where the vector generated may be sent as a payload request to the vector database service. Conversely, read operations are triggered during invoice upload events, with the vector generated may be sent as a read API request to the vector database service, which may then return the matching vendor for the invoice.

In various embodiments, this centralized vector storage strategy may offer several significant advantages over conventional systems. For example, by minimizing the need to regenerate vectors and avoiding duplication of embedding generation code, the system achieves reduced latency in vector operations. The decoupling of the vector service from core operations enhances the ease of experimentation, allowing for seamless testing of multiple vendors and facilitating rapid iterations in the embedding generation process.

Additionally, in various embodiments, scalability may be improved by use of the methods and systems disclosed herein. For example, the standalone vector service can scale independently, which in turn may optimize resource utilization and maintain performance as demand fluctuates. This approach also enables clear ownership separation, with one team (such as the ML Ops team) maintaining control over the vector service while transferring ownership of the model itself. In one particular embodiment, this division of responsibilities allows the AI platform team to focus on other critical aspects without the burden of managing embeddings, which may involve different models and techniques.

In various embodiments, the separation of the embedding generation service from the vector service on distinct endpoints may allow for independent scaling (which in turn may decrease potential bottlenecks that would otherwise arise from combining multiple functions on a single endpoint). Furthermore, this separation results in fewer moving parts within the vector database service, leading to faster development cycles and more efficient maintenance.

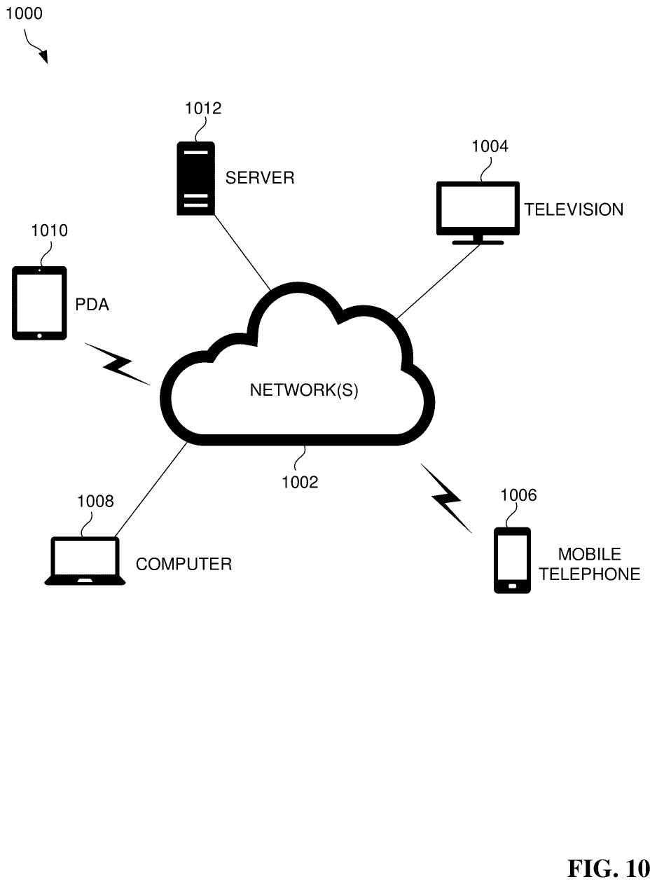

FIG. 10 illustrates a computing environment 1000 that includes multiple devices connected through a cloud network 1002, in accordance with one embodiment. As an option, the computing environment 1000 may be implemented in the context of any one or more of the embodiments set forth in any previous and/or subsequent Figures and/or description thereof. Of course, however, the computing environment 1000 may be implemented in the context of any desired environment. Further, the aforementioned definitions may equally apply to the description below.

The computing environment 1000 includes a cloud network 1002 that serves as a central connection point for various devices. A network server 1012 may connect to the cloud network 1002, enabling data processing and storage capabilities. A display device 1004 may connect to the cloud network 1002 for presenting visual information. A mobile device 1006 may maintain wireless connectivity to the cloud network 1002 for mobile access. A client computer 1008 may connect directly to the cloud network 1002 for general computing tasks. A tablet device 1010 may connect wirelessly to the cloud network 1002 for portable computing capabilities.

The cloud network 1002 may enable data exchange and resource sharing between the network server 1012, display device 1004, mobile device 1006, client computer 1008, and tablet device 1010. In some cases, the cloud network 1002 may facilitate the distribution of processing tasks related to the multimodal embedding system across multiple devices. For example, the network server 1012 may handle the generation and storage of multimodal embeddings, while the client computer 1008 or mobile device 1006 may be used for querying and retrieving recommendations.

The computing environment 1000 may support the various components of the multimodal embedding system described in previous embodiments. For instance, the embedding system 200 may be implemented on the network server 1012, with the input layer 204 receiving data from various connected devices. The system architecture 300 may leverage the cloud network 1002 for distributed processing and storage, with the storage database 324 potentially spanning multiple network servers 1012 for improved performance and redundancy.

In some cases, the client interface 308 of the system architecture 300 may be accessed through the display device 1004, mobile device 1006, client computer 1008, or tablet device 1010, providing users with flexible access to the multimodal embedding system. The query interface 602 and results interface 612 of the system architecture 600 may also be implemented across these various devices, allowing users to submit queries and view recommendations from different platforms.

To ensure data privacy and security within the computing environment 1000, the system may use AWS KMS (Amazon Web Services Key Management Service) and application level encryption. These security measures may protect sensitive vendor-payor network information as the data is transmitted across the cloud network 1002 and processed by various devices in the computing environment 1000.

The computing environment 1000 provides a flexible and scalable infrastructure for implementing the multimodal embedding system. By leveraging cloud computing resources and connecting multiple devices, the computing environment 1000 may enable efficient processing of large volumes of data, real-time querying capabilities, and secure access to business recommendations across various platforms.

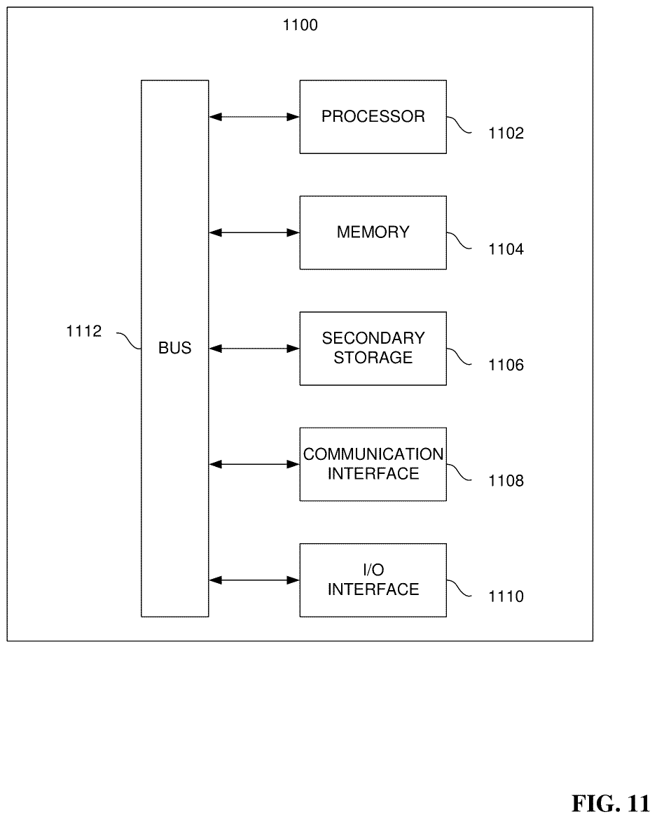

FIG. 11 illustrates a block diagram of a computing system 1100, in accordance with one embodiment. As an option, the computing system 1100 may be implemented in the context of any one or more of the embodiments set forth in any previous and/or subsequent Figures and/or description thereof. Of course, however, the computing system 1100 may be implemented in the context of any desired environment. Further, the aforementioned definitions may equally apply to the description below.

The computing system 1100 includes a processor 1102, a memory 1104, a secondary storage 1106, a communication interface 1108, an input output interface 1110, and a system bus 1112. The system bus 1112 may serve as a central communication pathway between the components, enabling data transfer and coordination between them.

The processor 1102 may execute instructions and process data for the multimodal embedding generation and matching processes. In some cases, the processor 1102 may perform operations related to the method 100, such as generating multimodal embeddings and implementing sanity checks to minimize false positives in recommendations.

The memory 1104 may provide temporary storage for active programs and data used by the processor 1102. In some cases, the memory 1104 may store the embeddings generated by the embedding system 200 or the embedding system 500 for quick access during matching operations.

The secondary storage 1106 may offer additional storage capacity for programs and data. In some cases, the secondary storage 1106 may store large volumes of historical data used by the embedding system to improve the quality of generated embeddings over time.

The communication interface 1108 may enable the computing system 1100 to communicate with external devices and networks. In some cases, the communication interface 1108 may facilitate data exchange between the computing system 1100 and other components of the computing environment 1000, such as the network server 1012 or the client computer 1008.

The input output interface 1110 may manage connections with input and output devices. In some cases, the input output interface 1110 may connect to the display device 1004 to present visual information related to the multimodal embeddings and business recommendations.

The components of the computing system 1100 may work together to support the multimodal embedding generation and matching processes. For example, the processor 1102 may execute instructions stored in the memory 1104 to implement the embedding layer 202 and the input layer 204 of the embedding system 200. The secondary storage 1106 may store the embeddings storage 606, while the communication interface 1108 may facilitate data transfer between the computing system 1100 and the storage database 324.

In some cases, the computing system 1100 may handle multilingual documents by incorporating a language-agnostic embedding model. The processor 1102 may execute this model, which may be stored in the memory 1104 or the secondary storage 1106, to generate embeddings for documents in various languages.

The computing system 1100 may also support the improvement of embedding quality over time using a triplet loss siamese network. This network may be implemented using the processor 1102 and memory 1104, with the secondary storage 1106 storing historical data for training. The triplet loss siamese network may minimize the distance between embeddings for similar inputs while maximizing the distance between embeddings for dissimilar inputs. This process may enhance the accuracy and relevance of the multimodal embeddings generated by the computing system 1100.

By leveraging the various components of the computing system 1100, the multimodal embedding generation and matching processes may be executed efficiently and effectively, supporting the overall functionality of the business recommendation system.

In another embodiment to ensure data privacy and security within the system, several robust measures may be implemented. Communication within the Virtual Private Cloud (VPC) may be secured using HTTPS to ensure that all data transmitted over the network is encrypted. Additionally, data at rest is protected through encryption using private keys, safeguarding sensitive information from unauthorized access. The system may also incorporate authentication and authorization protocols between services, which may help prevent unauthorized access by ensuring that only authenticated and authorized users can interact with the services.

To further enhance data security, a Security Assertion Markup Language (SAML) setup may be employed. This setup may ensure that vendor data is not inadvertently exposed to internal employees, as organizational Single Sign-On (SSO) is required to access the data. Moreover, field-level security measures may be in place to mask Personally Identifiable Information (PII), ensuring that this sensitive data is not visible even to authorized internal employees, thereby maintaining strict confidentiality and compliance with privacy regulations. These comprehensive security strategies collectively fortify the system against potential data breaches and unauthorized data access, ensuring a secure environment for handling sensitive vendor-payor information.

In another embodiment, the system may be enhanced to support multilingual capabilities. For example, multilingual capabilities may involve the integration of a separate language-agnostic embedding tower within the existing architecture. The language-agnostic embedding tower may utilize advanced natural language processing techniques, such as cross-lingual transformers or multilingual BERT models, to generate embeddings that capture semantic meaning across multiple languages. This tower may process input text in various languages and map them to a shared embedding space, allowing for consistent representation regardless of the input language. The language-agnostic embeddings may then be combined or aligned with the existing multimodal embeddings, enabling seamless integration of multilingual data into the system's analysis and recommendation processes. This approach may allow the system to handle queries and documents in multiple languages, perform cross-lingual similarity searches, and generate insights that span language barriers within the vendor-payor network.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for generating and matching multimodal embeddings for business recommendations, comprising:
a processor; and
a memory storing instructions that, when executed by the processor, cause the system to:
generate multimodal embeddings for vendor-payor network entities, wherein the multimodal embeddings comprise document embeddings, payor-vendor network interaction embeddings, payor segment embeddings, and vendor segment embeddings;
store the multimodal embeddings in a vector database;
retrieve embeddings from the vector database in response to a query for an entity;
match and rerank retrieved results against the query; and
implement sanity checks to minimize false positives in recommendations.

2. The system of claim 1, wherein generating the document embeddings comprises:
extracting textual information from documents;
analyzing positional information of text fields within the documents; and
capturing visual information, wherein the visual information includes at least two of logos, font sizes, or table designs.

3. The system of claim 2, wherein generating the document embeddings further comprises using a transformer architecture to process the textual information and the positional information.

4. The system of claim 3, wherein the transformer architecture includes at least one of: LayoutLM, models designed for document layout analysis, bi-directional transformers, decoder-only transformers, encoder-only transformers, or encoder-decoder transformers.

5. The system of claim 2, wherein capturing the visual information comprises:
locating the logos within the documents; and
determining logo representations using convolutional neural networks.

6. The system of claim 1, wherein generating the payor-vendor network interaction embeddings comprises analyzing:
payment frequency between payers and vendors;
payment amounts and dates;
bill descriptions;
line items; and
expense and approver chains.

7. The system of claim 1, wherein generating the payor segment embeddings comprises analyzing:
payer business information;
account software usage;
login information;
transaction behaviors; and
payment trends.

8. The system of claim 1, wherein generating the vendor segment embeddings comprises analyzing:
vendor information created by payers;
invoice documents sent to payers; and
payment methods accepted by vendors.

9. The system of claim 1, wherein storing the multimodal embeddings in the vector database comprises:
compressing the embeddings to reduce storage requirements;
storing metadata alongside the embeddings; and
sharding the embeddings across multiple nodes for parallel processing.

10. The system of claim 9, further comprising caching frequently accessed embeddings to reduce retrieval time.

11. The system of claim 1, wherein retrieving embeddings from the vector database comprises:
converting the query into a multimodal embedding tensor; and
performing a k-nearest neighbor search across distributed shards.

12. The system of claim 11, further comprising applying a merge sort algorithm to aggregate query results from distributed instances.

13. The system of claim 1, wherein matching and reranking retrieved results comprises:
calculating similarity scores between the query embedding and retrieved embeddings; and
ordering the results based on the similarity scores.

14. The system of claim 13, wherein calculating similarity scores comprises using cosine similarity.

15. The system of claim 1, wherein implementing sanity checks comprises:
applying a machine learning model trained on known information about documents, payment patterns, and payer-vendor preferences; and
optimizing the model using an F1 score to balance precision and recall.

16. The system of claim 1, further comprising personalizing recommendations for different users or entities by:
ingesting real-time updates of user and entity preferences; and
inferencing upon historical payer-vendor behaviors and trends.

17. The system of claim 1, further comprising detecting duplicate documents by:
generating document text embeddings from optical character recognition;
creating document entity recognition embeddings; and
comparing similarities between input embeddings and existing embeddings.

18. The system of claim 1, further comprising handling multilingual documents by incorporating a language-agnostic embedding model.

19. The system of claim 1, further comprising improving a quality of generated embeddings over time using a triplet loss siamese network.

20. The system of claim 19, wherein the triplet loss siamese network minimizes a distance between embeddings for similar inputs while maximizing a distance between embeddings for dissimilar inputs.
